(19) United States
(12) Patent Application Publication
(10) Pub. No.: US 2026/0359442 A1
(43) Pub. Date: Nov. 12, 2026

(54) ELECTRONIC DEVICE AND SYSTEM COMPRISING A PLURALITY OF CHIPLETS, AND SECURITY METHOD THEREOF

(71) Applicant: REBELLIONS INC., Seongnam-si (KR)

(72) Inventor: Myunghoon CHOI, Seongnam-si (KR)

(21) Appl. No.: 19/654,326

(22) Filed: Apr. 21, 2026

(30) Foreign Application Priority Data
May 9, 2025 (KR) 10-2025-0060637

(51) Int. Cl. G06F 21/57; G06F 21/72

(52) U.S. Cl. CPC G06F 21/575; G06F 21/72; G06F 2221/034

(57) ABSTRACT

An electronic device includes a plurality of chiplets including a main chiplet and at least one sub-chiplet. Each of the plurality of chiplets has a security core configured to control a booting operation, an immutable memory configured to store a current security cycle, a debugging interface configured to perform communication between the chiplet and an external device performing a debugging operation, and a main interface configured to perform communication between chiplets. The main chiplet controls the main interface based on the one or more security cycles of the at least one sub-chiplet.

### CROSS-REFERENCE TO RELATED APPLICATION

This application claims priority to Korean Patent Application No. 10-2025-0060637, filed in the Korean Intellectual Property Office on May 9, 2025, the entire contents of which are hereby incorporated by reference.

### BACKGROUND

### Field

The present disclosure relates to an electronic device, a system, and a security method thereof including a plurality of chiplets.

### Description of Related Art

As demand for high performance and miniaturization for semiconductor devices and electronic devices using the same increases, various package technologies related to semiconductor devices are being developed. As part of such technology development, package technology using chiplets has recently emerged.

A chiplet system may mean that chips performing various functions are not configured in one die (or substrate), but are divided by functional units and configured in each of a plurality of dies (chiplets), and these are packaged as one. That is, the chiplet system was developed to overcome limitations of a conventional monolithic chip, and dies in a package may be connected through a silicon interposer and may communicate according to a die-to-die communication standard such as UCIe (universal chiplet interconnect express).

Because such chiplets can be miniaturized by dividing the chiplets into functional units, a size limit of a reticle, which is a frame for printing a circuit on a surface of a wafer, can be overcome. Also, because a yield of semiconductor manufacturing tends to be inversely proportional to an area, when chiplets are used, the yield of semiconductor manufacturing may be increased, and manufacturing costs may be reduced. Accordingly, demand for using chiplets when manufacturing electronic products has recently increased.

On the other hand, as a plurality of chiplets are packaged into one, if one chiplet included in the packaging is attacked from the outside, a risk that the chiplets included in the packaging are also exposed to danger is also increasing. Therefore, there is an increasing demand for development of technology for a security method of a chiplet system including a plurality of chiplets.

### SUMMARY

The present disclosure relates to provide an electronic device, a system, and a security method thereof including a plurality of chiplets for solving the problems as described above.

Some embodiments may be implemented in various ways including a method, an apparatus (system), and/or a computer program stored in a computer-readable storage medium.

According to some embodiments of the present disclosure, an electronic device including a plurality of chiplets including a main chiplet and at least one sub-chiplet, each of the plurality of chiplets includes a security core configured to control a booting operation, an immutable memory configured to store a current security cycle, a debugging interface configured to perform communication between the chiplet and an external device performing a debugging operation, and a main interface configured to perform communication between chiplets, wherein the main chiplet may control the main interface based on the one or more security cycles of the at least one sub-chiplet.

In some embodiments, each of the plurality of chiplets may acquire the security cycle from the immutable memory in response to a booting signal, and may determine whether to activate the debugging interface based on the security cycle.

In some embodiments, each of the plurality of chiplets may enable the debugging interface in response to the security cycle being in a first state, and may disable the debugging interface in response to the security cycle being in a second state.

In some embodiments, the main chiplet may transmit a first request for acquiring the one or more security cycles of the at least one sub-chiplet, and the at least one sub-chiplet may be configured to transmit the one or more security cycles to the main chiplet in response to the first request.

In some embodiments, the main chiplet may disable the main interface of each of the plurality of chiplets in response to at least one of the security cycles received from the at least one sub-chiplet being in the first state.

In some embodiments, the main chiplet may disable the main interface of each of the plurality of chiplets in response to at least one of the security cycles received from the at least one sub-chiplet being not in the second state.

In some embodiments, the main chiplet may output a control signal so that the security core of each of the at least one sub-chiplet disables the main interface of each of the at least one sub-chiplet, in response to at least one of the security cycles received from the at least one sub-chiplet being in the first state.

In some embodiments, the main chiplet may gate a clock signal applied to the main interface of each of the plurality of chiplets.

According to an embodiment, each of the plurality of chiplets may further include a sub-interface configured to preliminarily perform communication between chiplets, and the main chiplet may be further configured to disable the sub-interface of each of the plurality of chiplets.

In some embodiments, the immutable memory of the main chiplet is further configured to store a public key corresponding to each of the at least one sub-chiplet, and the immutable memory of each of the at least one sub-chiplet may store a private key paired with the public key.

In some embodiments, the at least one sub-chiplet is further configured to encrypt the acquired one or more security cycles with the one or more private keys in response to the first request, and the main chiplet may decrypt the encrypted security cycle based on the one or more public keys paired with the one or more private keys.

In some embodiments, the main chiplet may store, in the immutable memory, status information for at least one sub-chiplet in which the one or more security cycles are in the first state.

In some embodiments the main chiplet may receive a second request for checking a security status of the plurality of chiplets from a host device, and may transmit the status information to the host device in response to the second request.

In some embodiments, the main chiplet may further include a PCIe (peripheral component interconnect express) interface configured to perform communication with the host device, and the main interface may include a UCIe (universal chiplet interconnect express) interface.

In some embodiments, the main chiplet is further configured to transmit a third request for integrity verification to each of the at least one sub-chiplet during runtime after completion of the booting operation, and each of the at least one sub-chiplet may be configured to transmit integrity verification data including a corresponding security cycle to the main chiplet in response to the third request.

According to some embodiments of the present disclosure, a chiplet system including a plurality of chiplets including a main chiplet and at least one sub-chiplet, each of the plurality of chiplets includes a security core configured to control a booting operation, an immutable memory configured to store a current security cycle, a debugging interface configured to perform communication between the chiplet and an external device performing a debugging operation, and a main interface configured to perform communication between chiplets, and is configured to acquire the security cycle from the immutable memory in response to a booting signal, the at least one sub-chiplet transmits the acquired one or more security cycles to the main chiplet in response to a provision request for the one or more security cycles by the main chiplet, and the main chiplet may disable the main interface of each of the plurality of chiplets in response to at least one of the one or more security cycles received from the at least one sub-chiplet being not in a state in which the debugging interface is disabled.

In some embodiments, the immutable memory of the main chiplet is further configured to store a public key corresponding to each of the at least one sub-chiplet, the immutable memory of each of the at least one sub-chiplet is further configured to store a private key corresponding to the public key, the at least one sub-chiplet is further configured to encrypt the one or more security cycles with the one or more private keys in response to the provision request, and the main chiplet may decrypt the encrypted security cycle based on the one or more public keys corresponding to the one or more private keys.

In some embodiments, the main chiplet may gate a clock signal applied to the main interface of each of the plurality of chiplets.

In some embodiments, the main chiplet is further configured to transmit a verification request for integrity verification to each of the at least one sub-chiplet during runtime after completion of the booting operation, and each of the at least one sub-chiplet may be configured to transmit integrity verification data including a corresponding security cycle to the main chiplet in response to the verification request.

According to some embodiments of the present disclosure, a security method of an electronic device including a plurality of chiplets including a main chiplet and at least one sub-chiplet, each including a security core configured to control a booting operation, an immutable memory configured to store a current security cycle, a debugging interface configured to perform communication between the chiplet and an external device performing a debugging operation, and a main interface configured to perform communication between chiplets, the security method including: acquiring, by the at least one sub-chiplet, the one or more security cycles from the one or more immutable memories in response to a booting signal; transmitting, by the at least one sub-chiplet, the acquired security cycle to the main chiplet in response to a provision request for the security cycle of the main chiplet; and disabling, by the main chiplet, the main interface of each of the plurality of chiplets in response to at least one of the security cycles received from the at least one sub-chiplet being in a state in which the debugging interface is enabled.

According to some embodiments of the present disclosure, a security cycle of each chiplet can be verified in a booting process. If an abnormal state of at least one chiplet is detected during a verification process, a situation where the entire chiplet system is exposed to an attack can be prevented by blocking communication between chiplets, and thus security and reliability of the device can be improved.

According to some embodiments of the present disclosure, a security cycle of each of a plurality of chiplets can be individually verified. Accordingly, a security process of the entire chiplet system can become more precise, and reliability can be improved.

According to some embodiments of the present disclosure, by performing signature and verification operations for a security cycle through a security key, reliability for the security cycle acquired by the chiplet can be increased, and an external intrusion can be more accurately identified.

According to some embodiments of the present disclosure, when a problem in a security cycle of a chiplet is recognized, a security issue can be tracked by storing corresponding status information. Also, a security process can be continuously managed through reporting to a host device or the like.

According to some embodiments of the present disclosure, even during runtime after a booting process, by including a security cycle verification process in an integrity verification process, the security cycle can be verified in real time or periodically. That is, a security cycle verification process for a plurality of chiplets can be performed both before and after booting, and reliability of a chiplet system can be further improved.

Effects of the present disclosure are not limited to the effects mentioned above, and other effects not mentioned will be clearly understood by those of ordinary skill in the art to which the present disclosure belongs (referred to as a “person skilled in the art”) from the description of the claims.

### BRIEF DESCRIPTION OF THE DRAWINGS

Embodiments of the present disclosure will be described with reference to the accompanying drawings described below, where like reference numerals indicate like elements, but are not limited thereto.

FIG. 1 illustrates a configuration of an electronic device including a plurality of chiplets according to an embodiment of the present disclosure.

FIG. 2 illustrates a configuration related to booting of an electronic device including a plurality of chiplets according to an embodiment of the present disclosure.

FIG. 3 illustrates a schematic operation of a chiplet according to an embodiment of the present disclosure.

FIG. 4 illustrates a specific configuration of a chiplet according to an embodiment of the present disclosure.

FIG. 5 is a flowchart illustrating a debugging interface control operation of a chiplet according to an embodiment of the present disclosure.

FIG. 6 is a flowchart illustrating a main interface control operation of a main chiplet according to an embodiment of the present disclosure.

FIG. 7 is a block diagram illustrating a main interface control operation of a main chiplet according to an embodiment of the present disclosure.

FIG. 8 is a block diagram illustrating an interface control operation through a security key according to an embodiment of the present disclosure.

FIG. 9 is a flowchart illustrating the control operation of FIG. 8.

FIG. 10 is a flowchart illustrating a logging operation according to an embodiment of the present disclosure.

FIG. 11 is a block diagram illustrating an interface control operation during runtime according to an embodiment of the present disclosure.

FIG. 12 is a flowchart illustrating the control operation of FIG. 11.

FIG. 13 is a flowchart illustrating a security method of an electronic device including a plurality of chiplets.

### DETAILED DESCRIPTION

Hereinafter, specific details for implementation of the present disclosure will be described in detail with reference to the accompanying drawings. However, in the following description, detailed descriptions of well-known functions or configurations will be omitted if there is a concern of unnecessarily obscuring the subject matter of the present disclosure.

In the accompanying drawings, the same or corresponding components are given the same reference numerals. Also, in the description of the following embodiments, duplicate descriptions of the same or corresponding components may be omitted. However, even if descriptions related to components are omitted, such components are not intended to be not included in a certain embodiment.

Advantages and features of the disclosed embodiments, and methods of achieving them, will become clear with reference to the embodiments described later together with the accompanying drawings. However, the present disclosure is not limited to the embodiments disclosed below but may be implemented in various different forms, and only these embodiments are provided to make the present disclosure complete and to fully inform a person skilled in the art of the scope of the invention.

Terms used in the present specification will be briefly described, and the disclosed embodiments will be described in detail. Terms used in the present specification selected general terms currently widely used as much as possible while considering functions in the present disclosure, but this may vary according to intentions of a technician working in a related field or precedents, emergence of new technology, etc. Also, in a specific case, there are terms arbitrarily selected by an applicant, and in this case, the meaning will be described in detail in the description of the corresponding invention. Therefore, terms used in the present disclosure should be defined based on meanings possessed by the terms and contents throughout the present disclosure, rather than simple names of the terms.

Singular expressions in the present specification include plural expressions unless the context clearly specifies the singular. Also, plural expressions include singular expressions unless the context clearly specifies the plural. Throughout the specification, when a part is said to include a certain component, this means that other components are not excluded but may be further included unless specifically stated otherwise.

Also, the terms ‘module’ or ‘part’ used in the specification mean software or hardware components, and a ‘module’ or ‘part’ performs certain roles. However, ‘module’ or ‘part’ is not meant to be limited to software or hardware. A ‘module’ or ‘part’ may be configured to be in an addressable storage medium and may be configured to reproduce one or more processors. Therefore, as an example, a ‘module’ or ‘part’ may include components such as software components, object-oriented software components, class components, and task components, and at least one of processes, functions, attributes, procedures, subroutines, segments of program code, drivers, firmware, microcode, circuits, data, databases, data structures, tables, arrays, or variables. Functions provided within components and ‘modules’ or ‘parts’ may be combined into a smaller number of components and ‘modules’ or ‘parts’ or further separated into additional components and ‘modules’or ‘parts’.

According to an embodiment of the present disclosure, a ‘module’ or ‘part’ may be implemented with a processor and a memory. A ‘processor’ should be interpreted broadly to include a general-purpose processor, a central processing unit (CPU), a microprocessor, a digital signal processor (DSP), a controller, a microcontroller, a state machine, etc. In some environments, a ‘processor’ may also refer to an application-specific integrated circuit (ASIC), a programmable logic device (PLD), a field programmable gate array (FPGA), etc. A ‘processor’ may also refer to a combination of processing devices, such as, for example, a combination of a DSP and a microprocessor, a combination of a plurality of microprocessors, a combination of one or more microprocessors combined with a DSP core, or any other such combination of configurations. Also, ‘memory’ should be interpreted broadly to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, etc. If the processor can read information from the memory and/or write information to the memory, the memory is said to be in electronic communication with the processor. A memory integrated in the processor is in electronic communication with the processor.

Also, terms such as first, second, A, B, (a), (b), etc. used in the following embodiments are only used to distinguish a component from other components, and nature, order, or sequence of the corresponding component is not limited by the terms.

Also, in the following embodiments, when it is described that a component is ‘connected’, ‘coupled’ or ‘joined’ to another component, the component may be directly connected or joined to the other component, but it should be understood that another component may be ‘connected’, ‘coupled’ or ‘joined’ between each component.

Also, ‘comprises’ and/or ‘comprising’ used in the following embodiments do not exclude existence or addition of one or more other components, steps, operations and/or elements.

Also, in the following embodiments, ‘each of a plurality of A’ may refer to each of all components included in the plurality of A, or may refer to each of some components included in the plurality of A.

Hereinafter, various embodiments of the present disclosure will be described in detail according to the accompanying drawings.

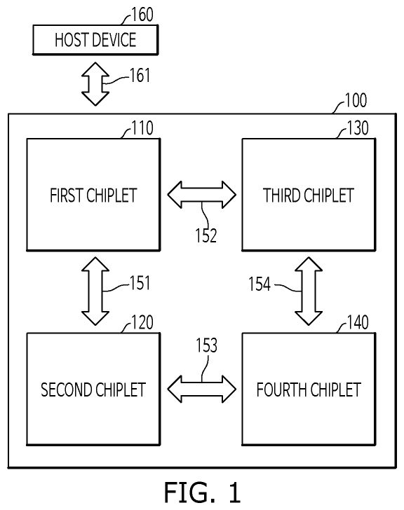

FIG. 1 illustrates a configuration of an electronic device including a plurality of chiplets according to an embodiment of the present disclosure. Referring to FIG. 1, an electronic device 100 may include a plurality of chiplets. For example, the electronic device 100 may include a first chiplet 110, a second chiplet 120, a third chiplet 130, and a fourth chiplet 140. However, the number of chiplets included in the electronic device 100 is not limited thereto. According to various embodiments, the electronic device 100 may omit at least one of the above-mentioned chiplets, and may further include at least one other chiplet. The electronic device 100 including the plurality of chiplets may be packaged, and accordingly, may be referred to as a package device or a chiplet system.

The plurality of chiplets may be connected to each other through an interface. In an embodiment, an interface between the plurality of chiplets may be referred to as a main interface. For example, the first chiplet 110 and the second chiplet 120 may be connected through a first main interface 151, the first chiplet 110 and the third chiplet 130 may be connected through a second main interface 152, the second chiplet 120 and the fourth chiplet 140 may be connected through a third main interface 153, and the third chiplet 130 and the fourth chiplet 140 may be connected through a fourth main interface 154. According to an embodiment, the first to fourth main interfaces 151-154 may refer to a die-to-die interface, and may include, for example, a UCIe (universal chiplet interconnect express) interface or the like.

Any one chiplet among the plurality of chiplets (for example, the first chiplet 110) may be connected to a host device 160 through a host interface 161. At this time, remaining chiplets (for example, the second chiplet 120, the third chiplet 130, and the fourth chiplet 140) may be restricted in communication with the host device 160. Here, a chiplet communicating with an external device (for example, the first chiplet 110) may be referred to as a main chiplet, a primary die, a base chiplet, etc., and the remaining chiplets (for example, the second chiplet 120, the third chiplet 130, and the fourth chiplet 140) restricted in communication with the host device 160 may be referred to as a sub-chiplet, a secondary die, a partner chiplet, etc. According to an embodiment, the host interface 161 may include, for example, a PCIe (peripheral component interconnect express) interface or the like.

According to an embodiment, the electronic device 100 including the plurality of chiplets, that is, the chiplet system, can expand functions of the host device 160 (or host system) and perform parallel processing for at least some functions. For example, the host device 160 can manage the chiplet system and distribute tasks related to at least some functions to the chiplet system, and the chiplet system can process the distributed tasks in parallel. Through this, not only is performance of an entire system including the host device 160 and the chiplet system optimized and increased, but a scalable computing environment can be provided. According to an embodiment, the chiplet system can perform functions such as multiple processors, a memory controller, a cache, and a network interface.

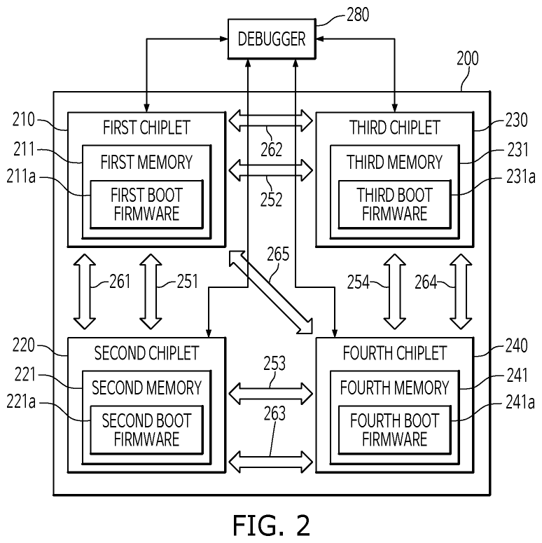

FIG. 2 illustrates a configuration related to booting of an electronic device including a plurality of chiplets according to an embodiment of the present disclosure. Referring to FIG. 2, an electronic device 200 (for example, the electronic device 100 of FIG. 1) including a plurality of chiplets (for example, a first chiplet 210, a second chiplet 220, a third chiplet 230, and/or a fourth chiplet 240), that is, a chiplet system, can perform a booting operation (or a booting process) when power is supplied and a signal related to booting (for example, a booting signal, a reset signal, etc.) is received. The first chiplet 210, the second chiplet 220, the third chiplet 230, and the fourth chiplet 240 may correspond to the first chiplet 110, the second chiplet 120, the third chiplet 130, and the fourth chiplet 140 of FIG. 1, respectively.

The booting process may include an operation of initializing and setting a hardware configuration so that at least one of application firmware or an operating system can be loaded and executed according to functions of the electronic device 200. This booting process can proceed by execution of boot firmware (for example, a first boot firmware 211a, a second boot firmware 221a, a third boot firmware 231a, and/or a fourth boot firmware 241a). In the following description, for convenience, the chiplet system is described as including four chiplets, for example, the first chiplet 210, the second chiplet 220, the third chiplet 230, and the fourth chiplet 240, but the number of chiplets is not limited thereto.

The booting process can proceed when power is supplied to the chiplet system and a signal related to booting is received. First, initial settings necessary for driving chiplets can be performed. For example, the chiplet system can initialize first to fourth main interfaces 251-254 for inter-chiplet connection. The first to fourth main interfaces 251-254 may correspond to the first to fourth main interfaces 151-154 of FIG. 1, and the first to fourth main interfaces 251-254 may refer to a die-to-die interface, and may include, for example, UCIe or the like.

The booting process can proceed by execution of boot firmware stored in a memory included in each of the plurality of chiplets. For example, the first chiplet 210 includes a first memory 211, and the booting process for the first chiplet 210 can proceed by execution of the first boot firmware 211a stored in the first memory 211. Also, the second chiplet 220 includes a second memory 221, and the booting process for the second chiplet 220 can proceed by execution of the second boot firmware 221a stored in the second memory 221. Also, the third chiplet 230 includes a third memory 231, and the booting process for the third chiplet 230 can proceed by execution of the third boot firmware 231a stored in the third memory 231. Also, the fourth chiplet 240 includes a fourth memory 241, and the booting process for the fourth chiplet 210 can proceed by execution of the fourth boot firmware 241a stored in the fourth memory 241. Here, the memory inside the plurality of chiplets (for example, the first memory 211, the second memory 221, the third memory 231, and the fourth memory 241) where the boot firmware (e.g., the first boot firmware 211a, the second boot firmware 221a, the third boot firmware 231a, and the fourth boot firmware 241a) is stored may include non-volatile memory.

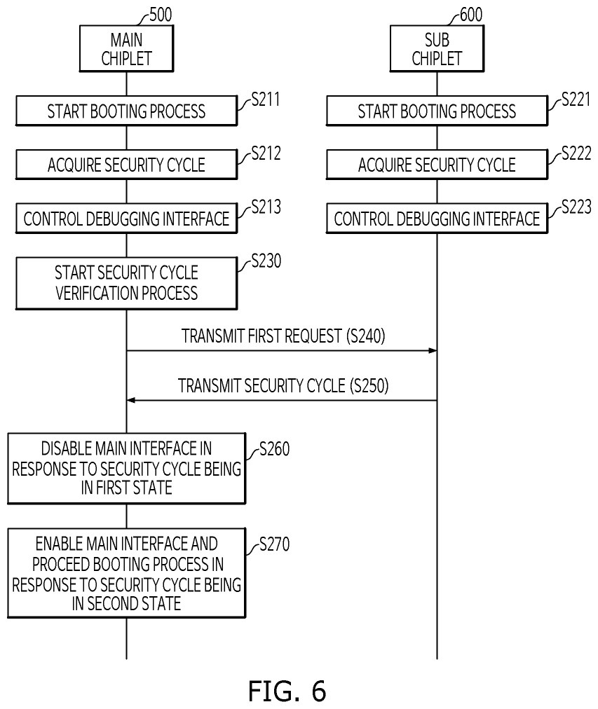

Thereafter, settings for inter-chiplet interconnection can proceed. For example, the chiplet system can set a connection method of the first to fourth main interfaces 251-254 for inter-chiplet connection through setting information for inter-chiplet interconnection. In the setting information, information for data transmission and reception between chiplets may be included. Also, the chiplet system can initialize a memory to load at least one of application firmware or an operating system. At this time, the initialized memory may include volatile memory (for example, dynamic random access memory (DRAM) and/or static random access memory (SRAM)). In an embodiment, when the inter-chiplet interconnection setting is completed, the main chiplet (for example, the first chiplet 210) can receive information about a security cycle (or security lifecycle) of a sub-chiplet (for example, the second chiplet 220, the third chiplet 230, and/or the fourth chiplet 240) through the first to fourth main interfaces 251-254. A control operation of the main chiplet for acquiring the security cycle of the sub-chiplet is described later in detail with reference to FIG. 6 and the like.

Meanwhile, in the booting process, settings for connection between a chiplet and an external device can also proceed. In an embodiment, each of the plurality of chiplets can control a debugging interface based on a security cycle of the chiplet. For example, when the security cycle is in a state that does not allow an external debugging operation, the chiplet can deactivate (or block) the debugging interface. On the other hand, when the security cycle is in a state that allows an external debugging operation, the chiplet can activate (or allow) the debugging interface. In this case, the chiplet can be connected to an external device for debugging (for example, a debugger 280). A state check of each chiplet can be performed by the debugger 280. The debugger 280 can perform analysis for an error or an abnormal phenomenon of the chiplet system (or each of chiplets) through the debugging interface. That is, external access to a security domain is strictly limited, but access by the debugger 280 or the like can be allowed according to the security cycle.

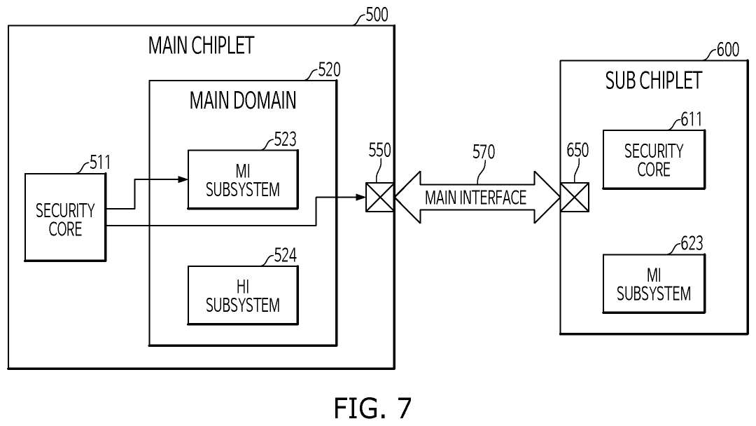

At this time, if there is an external attack approaching a security system inside a chiplet (for example, a security domain) through the debugging interface, security information, data, etc. inside the chiplet may be exposed. Also, as described above, because settings for inter-chiplet interconnection proceed in the booting process, if an attacker intrudes through a debugging interface of any one chiplet among the plurality of chiplets, the attacker can also intrude into other chiplets through an interconnection (for example, the first to fourth main interfaces 251-254). Therefore, if even any one chiplet is exposed to a debugging interface intrusion, it may be fatal to the entire chiplet system. In an embodiment, to defend against such an external attack, when the main chiplet (for example, the first chiplet 210) detects an intrusion through the debugging interface, the main chiplet can deactivate (or block) the inter-chiplet interconnection to block the entire chiplet system from being exposed to the attack. For example, the main chiplet can deactivate the first to fourth main interfaces 251-254. A control operation of the main chiplet for deactivating the main interface is described later in detail with reference to FIG. 6, FIG. 7, and the like.

first to fifth sub-interfaces 261-265 may be referred to as a backup interface. For example, the first to fifth sub-interfaces 261-265 may be interfaces for preliminarily supporting communication between chiplets when the first to fourth main interfaces 251-254 are unavailable or deactivated. The first to fifth sub-interfaces 261-265 may be set to have a slower data transmission and reception speed than the first to fourth main interfaces 251-254 for inter-chiplet connection. For example, the first to fifth sub-interfaces 261-265 may include a serial peripheral interface (SPI). Or, for example, the first to fifth sub-interfaces 261-265 may include interfaces such as secure jtag (secure joint test action group), general purpose input/output (GPIO), and inter integrated circuit (I2C). In an embodiment, as described above, to block an external attack through the debugging interface, when the main chiplet (for example, the first chiplet 210) detects an intrusion through the debugging interface, the main chiplet can deactivate the first to fifth sub-Interfaces 261-265 as well.

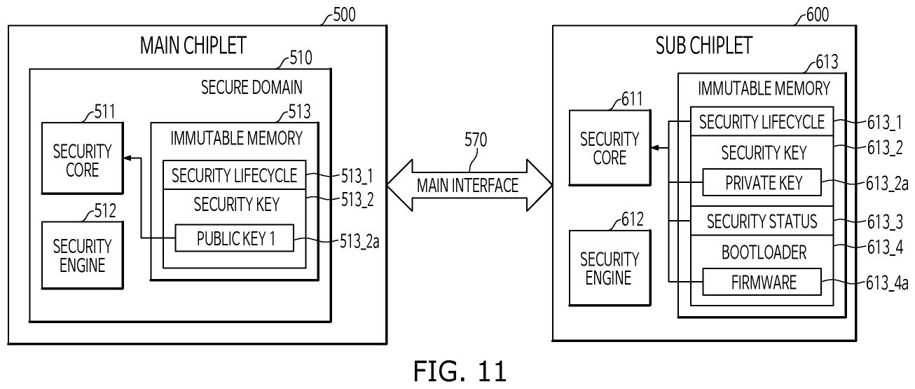

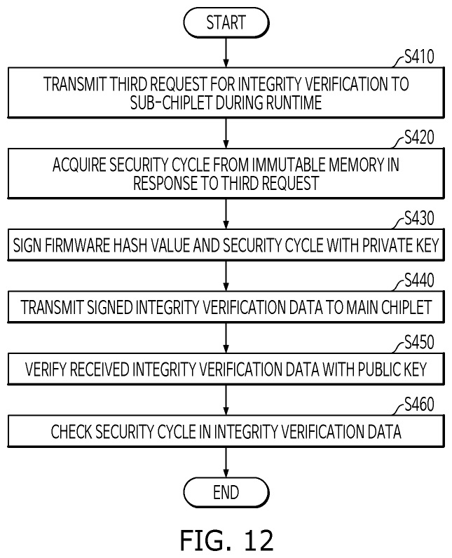

In an embodiment, the main chiplet (for example, the first chiplet 210) can perform a runtime integrity check for at least one chiplet (for example, a sub-chiplet) included in the chiplet system after completion of the booting process. For example, the main chiplet can load at least one of application firmware or an operating system into a memory (for example, DRAM), and then perform a real-time integrity verification for the main chiplet and the at least one sub-chiplet. In an embodiment, during the real-time integrity verification process, the main chiplet (for example, the first chiplet 210) can verify one or more security cycles of the at least one sub-chiplet (for example, the second chiplet 220, the third chiplet 230, and/or the fourth chiplet 240). A runtime security cycle verification process is described later in detail with reference to FIG. 11, FIG. 12, and the like.

An electronic device including a plurality of chiplets according to an embodiment of the present disclosure can verify a security cycle of each chiplet in a booting process, and when detecting an abnormal state of at least one chiplet during a verification process, can prevent a risk that the entire chiplet system is exposed to an attack by blocking communication between chiplets. Therefore, security and reliability of the device can be improved.

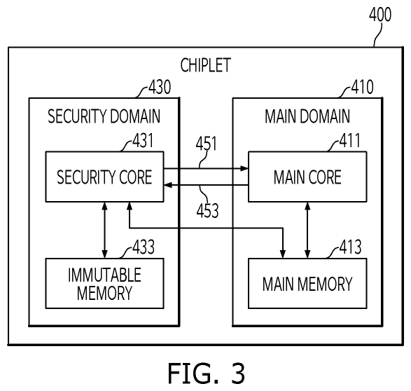

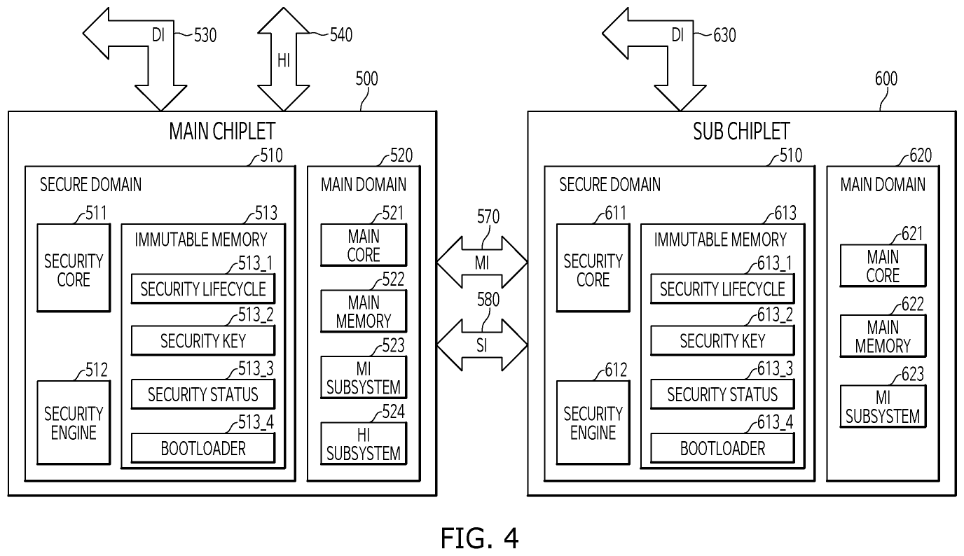

FIG. 3 illustrates a schematic operation of a chiplet according to an embodiment of the present disclosure. Referring to FIG. 3, a chiplet 400 (for example, the first chiplet 210, the second chiplet 220, the third chiplet 230, and/or the fourth chiplet 240 of FIG. 2) included in a chiplet system may be divided into a main domain 410 and a security domain 430. In the main domain 410, a main core 411 and a main memory 413 may be included, and in the security domain 430, a security core 431 and an immutable memory 433 may be included. However, a configuration of the chiplet 400 is not limited thereto. According to various embodiments, the chiplet 400 may omit at least one of the components described above, and may further include at least one other component. A description of this is described later in detail with reference to FIG. 4.

The main core 411 may be a core performing an operation task. Additionally or alternatively, the main core 411 may be a core that manages cores performing operation tasks or distributes tasks. For example, the main core 411 can load data stored in the main memory 413 and process (for example, operate) or drive the data. However, a type or function of the main core 411 is not limited thereto.

The main memory 413 may include volatile memory belonging to the main domain 410. The main memory 413 may include memory for storing and/or processing data and/or software during operations of the main core 411 and the security core 431. That is, data in use may be stored in the main memory 413. According to an embodiment, the main memory 413 may correspond to a memory where at least one of application firmware or an operating system used during the booting process or runtime described in FIG. 2 is loaded. For example, at least one of application firmware or an operating system may be loaded in the main memory 413. The main domain 410 may include the main core 411 and a hardware and/or software area used for operation tasks of the main core 411. For example, the main domain 410 may include the main memory 413.

The security core 431 may be a core performing operation tasks for security purposes. Additionally or alternatively, the security core 431 may be a core that manages cores performing operation tasks for security purposes or distributes tasks. For example, the security core 431 can acquire a security cycle of the chiplet 400 in a booting process, and can determine whether to activate a debugging interface according to the security cycle. Or for example, the security core 431 can perform integrity verification for at least some data stored in the main memory 413 periodically or aperiodically. Also, the security core 431 should be able to stop operations of all systems except for the security core 431 when a security-related problem (for example, detection of a debugging interface attack or integrity verification failure) occurs, and thus may have a highest priority among cores of the chiplet 400. Under such a configuration, the security core 431 may be accessible to all configurations of the chiplet 400.

The security core 431 may include hardware and/or software that manages an encryption process associated with an encryption operation and/or a decryption operation. For example, the security core 431 may include a block in charge of generation and management of an encryption key. In an embodiment, the security domain 430 may include the immutable memory 433. In the immutable memory 433, an encryption key (for example, a key generated in the security core 431 or a key transmitted from outside the system) and individual encryption key information may be stored. Access to the immutable memory 433 may be possible only by the security core 431. In FIG. 3, it has been described that hardware and/or software for managing the encryption process is included in the security core 431, but this is only for convenience of description and is not limited thereto. According to an embodiment, an encryption key manager that manages the encryption process may be included in the security domain 430 as a separate configuration from the security core 431.

The security domain 430 may include the security core 431 and a hardware and/or software area used for operation tasks of the security core 431. Because the security domain 430 is an area where security-related tasks are performed, other configurations inside/outside the system except for the security core 431 can access the security core 431 only for limited purposes such as sending an access request for encrypted data, and access to the security domain 430 excluding this may be restricted. In an embodiment, external access may be allowed to perform a debugging operation according to a security cycle of the chiplet 400, and if the access is an access by an attacker without legitimate authority, the security core 431 can stop operations of all systems. For example, the security core 431 can deactivate (or block) inter-chiplet connections to block attacks on other chiplets.

A security main interconnection 451 can transfer data and/or a control signal between the security core 431 and the main core 411. At this time, the security core 431 may have a higher priority than the main core 411. Accordingly, the security core 431 can access all parts of the main core 411, and can also instruct whether the main core 411 operates. Accordingly, when a security-related problem occurs, the security core 431 stops an operation of the main core 411 and can have control authority over the entire system. A main security interconnection 453 can transfer data and a control signal between the main core 411 and the security core 431. At this time, the main core 411 can access only a limited portion of the security core 431, rather than the entire security core 431, through the main security interconnection 453. Accordingly, security of the security core 431 in charge of security can be maintained, and a risk of tampering with the chiplet 400 can be prevented.

FIG. 4 illustrates a specific configuration of a chiplet according to an embodiment of the present disclosure. Referring to FIG. 4, a chiplet system includes a main chiplet 500 and a first sub-chiplet 600. The main chiplet 500 may correspond to the first chiplet 210 of FIG. 2 and the chiplet 400 of FIG. 3, and the first sub-chiplet 600 may correspond to the second chiplet 220, the third chiplet 230, and/or the fourth chiplet 240 of FIG. 2 and the chiplet 400 of FIG. 3. Descriptions overlapping with those described in FIG. 3 may be omitted. The main chiplet 500 and the first sub-chiplet 600 may include debugging interfaces 530 and 630 respectively performing communication with a debugging device (for example, the debugger 280 of FIG. 2) for intra-chiplet analysis. In an embodiment, whether the debugging interfaces 530 and 630 are activated may be determined according to a security cycle. For example, the debugging interfaces 530 and 630 may be enabled or disabled.

A security core 511 of the main chiplet 500 and a security core 611 of the first sub-chiplet 600 may be cores that perform operation tasks for security purposes of each chiplet as described above with reference to FIG. 3, and operation tasks of each security core can be performed using security engines 512 and 612. The security engines 512 and 612 may be engines for accelerating operations in an encryption process. For example, the security engines 512 and 612 may be engines performing an advanced encryption standard (AES) algorithm and/or a secure hash algorithm (SHA), or may be engines performing a digital signature using an encryption key or the like. Also for example, the security engines 512 and 612 can perform runtime encryption operations. In FIG. 4, the security engines 512 and 612 are illustrated as if they are separate configurations from the security cores 511 and 611, but this is only for convenience of description and is not limited thereto. According to an embodiment, at least some configurations of the security engines 512 and 612 may be included in the security cores 511 and 611.

An immutable memory 513 of the main chiplet 500 and an immutable memory 613 of the first sub-chiplet 600 may be implemented as non-volatile memory, and for example, may be one-time programmable (OTP) memory in which writing is possible only once. Data written to the immutable memories 513 and 613 may be permanently impossible to change and/or delete thereafter. In the immutable memories 513 and 613, for security and/or encryption processes of the chiplets, data that is not changed even by access by hardware or firmware/software may be stored. In an embodiment, the immutable memories 513 and 613 can store data related to security and encryption such as an ID unique to the chiplet, a physical unclonable function (PUF) seed, a security key, a security cycle, and a security status.

In an embodiment, a security cycle (or security lifecycle) may be stored in security cycle areas 513_1 and 613_1 of the immutable memories 513 and 613. The security cycle may be information indicating a current security stage of the chiplet. For example, the security cycle may include an initial stage before shipment (or a blank stage), a test stage, an operation stage (or a mission stage), an analysis stage (or a return merchandise authorization (RMA) stage), and a discard stage (or a decommission stage). The initial stage is a stage before shipment, and may mean a state in which data is not written to the chiplet. That is, because it is a state in which there is no data to protect, the debugging interfaces 530 and 630 can be enabled (or activated or allowed). The test stage is a stage for testing the chiplet, and may be a stage of proceeding with functional development and verification of the chiplet while writing data, and therefore the debugging interfaces 530 and 630 can be enabled for development and verification. The operation stage (or mission stage) is a state in which the chiplet has been shipped after completing development, and because it is a stage in which the chiplet is actually operated, the debugging interfaces 530 and 630 can be disabled (or deactivated or blocked) for security of the chiplet. The analysis stage (or RMA stage) may be a stage of collecting and performing analysis on the chiplet when a defect or the like occurs in the chiplet, and the debugging interfaces 530 and 630 can be enabled for analysis inside the chiplet. The discard stage (or decommission stage) may be a stage of discarding the chiplet after analysis of the chiplet, and the debugging interfaces 530 and 630 can be disabled for security of the chiplet. In an embodiment, the security cycle may be classified into a first state in which the debugging interfaces 530 and 630 are enabled and a second state in which the debugging interfaces 530 and 630 are disabled. For example, security cycles of the initial stage, the test stage, and the analysis stage may be classified into the first state, and security cycles of the operation stage and the discard stage may be classified into the second state. That is, the debugging interfaces 530 and 630 can be enabled or disabled according to whether it is the first state or the second state.

As described above, each stage of the security cycle can be stored in the immutable memories 513 and 613, and therefore values stored in relation to the security cycle can only be sequentially increased. That is, each stage can only proceed unilaterally to the next stage, and once the security cycle proceeds, it cannot be returned to a previous cycle.

Above, the security cycle has been exemplified as an initial stage, a test stage, an operation stage, an analysis stage, and a discard stage, but this is only for convenience of description and is not limited thereto. For example, each stage of the security cycle may be referred to by another name, or other stages besides the above stages may be further added or more specifically embodied into other stages. However, in any case, the security cycle may be classified into a first state in which the debugging interfaces 530 and 630 are enabled and a second state in which the debugging interfaces 530 and 630 are disabled.

In an embodiment, information related to a security key may be stored in security key areas 513_2 and 613_2 of the immutable memories 513 and 613. For example, the security key areas 513_2 and 613_2 can store data related to the encryption key described above with reference to FIG. 3. Or for example, the security key area 513_2 of the main chiplet 500 can store a public key, and the security key area 613_2 of the first sub-chiplet 600 can store a private key. The public key and the private key may be data paired with each other, and therefore public keys corresponding to private keys of a plurality of sub-chiplets may be stored in the security key area 513_2 of the main chiplet 500.

In an embodiment, security status areas 513_3 and 613_3 of the immutable memories 513 and 613 can store information about a security history or a boot state (or boot mode) of the chiplet. Boot loader areas 513_4 and 613_4 of the immutable memories 513 and 613 can store data for proceeding with a booting process, for example, data for boot firmware, verification, or OS execution. Although not illustrated in security domains 510 and 610 of FIG. 4, various configurations for executing a booting process and/or a security process may be further included in the security domain 430. For example, the security domains 510 and 610 may further include a separate memory (for example, SRAM) for executing firmware/software related to a booting process or a security process.

A main domain 520 of the main chiplet 500 and a main domain 620 of the first sub-chiplet 600 may correspond to the main domain 410 of FIG. 3, and main cores 521 and 621 and main memories 522 and 622 may correspond to the main core 411 and the main memory 413 of FIG. 3, respectively. The main domains 520 and 530 may be domains that perform overall operation tasks of the chiplets, and can be distinguished from the security domains 510 and 610, which are security areas.

In an embodiment, the main domains 520 and 620 include main interface sub-systems 523 and 623. The main interface sub-systems 523 and 623 may be sub-systems that control a main interface 570 supporting communication between chiplets. The main interface 570 may correspond to the first to fourth main interfaces 251-254 of FIG. 2. For example, the main interface sub-systems 523 and 623 can transmit and receive data and signals between chiplets (for example, the main chiplet 500 and the first sub-chiplet 600) through the main interface 570. The main interface sub-systems 523 and 623, although not illustrated in FIG. 4, can further support communication between a corresponding chiplet and a plurality of other sub-chiplets. Also, although not illustrated in FIG. 4, the main domains 520 and 620 may further include a sub-system that controls a sub-interface 580 that preliminarily supports communication between chiplets. The sub-interface 580 may correspond to the first to fifth sub-interfaces 261-265 of FIG. 2. Unlike the main domain 620 of the first sub-chiplet 600, the main domain 520 of the main chiplet 500 may further include a host interface sub-system 524. The host interface sub-system 524 may be a sub-system that controls a host interface 540 supporting communication between the main chiplet 500 and a host device (for example, the host device 160 of FIG. 1).

As described above with reference to FIG. 3, the security domains 510 and 610 may have a higher priority than the main domains 520 and 620, and can also instruct whether the main domains 520 and 620 operate. That is, in a specific situation, the security domains 510 and 610 can have control authority over the entire system. In an embodiment, when a security-related problem occurs (for example, when an external intrusion occurs through a security cycle), the security core 511 of the main chiplet 500 can disable the main interface 570 by controlling a first main interface sub-system 523 of the main domain 520 to prevent an external attack from spreading to other chiplets through communication between chiplets.

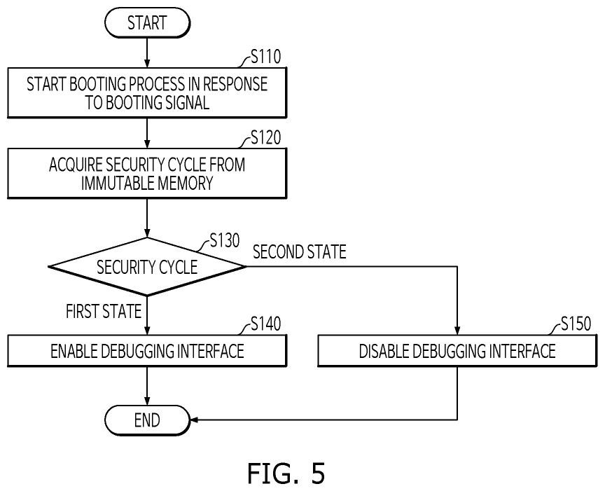

FIG. 5 is a flowchart illustrating a debugging interface control operation of a chiplet according to an embodiment of the present disclosure. Referring to FIG. 4 and FIG. 5, each chiplet can control the debugging interfaces 530 and 630 based on a security cycle. For convenience of description, the description below is based on the first sub-chiplet 600. The description for the first sub-chiplet 600 can be equally applied to a plurality of sub-chiplets not illustrated in FIG. 4 (for example, the second chiplet 220, the third chiplet 230, and/or the fourth chiplet 240 of FIG. 2).

In step S110, the security core 611 of the first sub-chiplet 600 can start a booting operation (or a booting process) when a signal related to booting (for example, a booting signal, a reset signal, etc.) is received. The booting process may include an operation of initializing and setting hardware and software configurations of the first sub-chiplet 600 so that at least one of application firmware or an operating system can be loaded and executed. For example, after the first sub-chiplet 600 initializes the main interface 570 for inter-chiplet connection, settings for inter-chiplet interconnection can proceed.

In step S120, the first sub-chiplet 600 can acquire a security cycle from the immutable memory 613. The security cycle may be information indicating a current security stage of the first sub-chiplet 600. More specifically, the security core 611 can acquire data for the security cycle in the security cycle area 613_1 of the immutable memory 613.

In step S130, the security core 611 can determine a state of the acquired security cycle. As described above, for example, the security cycle can be variously configured into an initial stage (or blank stage), a test stage, an operation stage (or mission stage), an analysis stage (or RMA stage), a discard stage (or decommission stage), etc., and the security cycle can be classified into a first state in which a debugging operation is allowed and a second state in which a debugging operation is not allowed.

When the security cycle is in the first state (for example, when the security cycle is in the RMA stage), in step S140, the security core 611 can enable (or activate or allow) the debugging interface 630 so that a debugging operation by an external device can be performed. On the other hand, when the security cycle is in the second state (for example, when the security cycle is in the mission stage), in step S150, the security core 611 can disable (or deactivate or block) the debugging interface 630 to block access by an external device.

FIG. 6 is a flowchart illustrating a main interface control operation of a main chiplet according to an embodiment of the present disclosure. Referring to FIG. 4 to FIG. 6, the main chiplet 500 can control whether to activate the main interface 570, which performs communication between chiplets, according to a security cycle to block an external attack through the debugging interfaces 530 and 630.

First, in steps S211, S212, and S213, after starting a booting process, the main chiplet 500 can acquire a security cycle and control the first debugging interface 530 according to the acquired security cycle. Similarly, in steps S221, S222, and 223, after starting a booting process, the first sub-chiplet 600 can acquire a security cycle and control the second debugging interface 630 according to the acquired security cycle. Steps S211 to S213 and steps S221 to S223 may correspond to steps S110 to S150 described with reference to FIG. 5.

In step S230, the main chiplet 500 can start a process of verifying the security cycle of the first sub-chiplet 600. For example, the main chiplet 500 can complete settings for inter-chiplet interconnection during the booting process to transmit and receive data and signals with the first sub-chiplet 600. For example, settings for the main interface 570 can be completed.

In step S240, the main chiplet 500 can transmit a first request for acquiring the security cycle of the first sub-chiplet 600. In step S250, the first sub-chiplet 600 can transmit the security cycle acquired in step S222 to the main chiplet 500 in response to the first request. A transmission and reception process of step S240 and step S250 can be performed through the main interface 570.

Meanwhile, in a stage where a chiplet is actually operated, although access by an external device such as debugging should be blocked for security of the chiplet system, if the security cycle of the chiplet is changed to a next stage (for example, an analysis stage) due to an external attack or the like, the debugging interface can be activated. After an attacker intrudes into the chiplet through the activated debugging interface, the attacker can also intrude into other chiplets through an inter-chiplet interface. Therefore, in this case, the inter-chiplet connection may need to be disabled to block the entire chiplet system from being exposed to the attack.

Returning again, in step S260, when the security cycle of the first sub-chiplet 600 is in the first state (or when it is not in the second state), that is, when the second debugging interface 630 of the first sub-chiplet 600 is enabled, the main chiplet 500 can disable the main interface 570. In other words, although the second debugging interface 630 of the first sub-chiplet 600 should be disabled in an actual operation stage, the fact that the security cycle of the first sub-chiplet 600 is in the first state (or is not in the second state) may mean that the second debugging interface 630 has been activated by a user without legitimate authority. Therefore, the main chiplet 500 can disable the main interface 570 to prevent the entire chiplet system from being exposed to the attack. In an embodiment, the main chiplet 500 can stop the booting process to prevent the booting process from continuing to proceed in a state exposed to the attack.

On the other hand, in step S270, when the security cycle of the first sub-chiplet 600 is in the second state, it means that the second debugging interface 630 is in a normally disabled state, and thus the main chiplet 500 can continue to proceed with the booting process.

An electronic device including a plurality of chiplets according to some embodiments of the present disclosure can individually verify a security cycle of each of a plurality of chiplets. When any one of the plurality of chiplets is exposed to an attack, a phenomenon in which the entire chiplet system is exposed to the attack can be prevented by blocking communication between chiplets. Therefore, a security process of the entire chiplet system can become more precise, and reliability can be improved.

FIG. 7 is a block diagram illustrating a main interface control operation of a main chiplet according to an embodiment of the present disclosure. Referring to FIG. 7, the main chiplet 500 can deactivate the main interface 570 to block an external intrusion.

As described above, when a problem occurs in security of the chiplet system, the security core 511 can have control authority over the entire system. In an embodiment, when any one sub-chiplet among a plurality of sub-chiplets (for example, the first sub-chiplet 600) is exposed to an attack, the security core 511 of the main chiplet 500 can disable the main interface 570, which performs communication between chiplets. Although not illustrated in FIG. 7, the security core 511 can block communication between other sub-chiplets besides the main interface 570, that is, all die-to-die interfaces in the system.

In an embodiment, the security core 511 can directly disable the main interface 570. For example, the security core 511 can deactivate the main interface 570 by directly applying a signal to a first data pad 550 connected to the main interface 570. The security core 511 can control the main interface 570 not to operate according to a clock signal by applying a signal maintained at a logic low level to the first data pad 550. That is, the security core 511 can gate a clock signal. Or, for example, the security core 511 can control the main interface 570 to be deactivated by controlling a clock generator that applies a clock signal to the main interface 570.

In an embodiment, the security core 511 can disable the main interface 570 by controlling the main domain 520. For example, the security core 511 can block transmission and reception of data and signals through the main interface 570 by directly controlling the first main interface sub-system 523. Or, the security core 511 can transmit a control signal instructing blocking of the main interface 570 to a main core of the main domain 520.

In an embodiment, the security core 511 of the main chiplet 500 can disable the main interface 570 by controlling the security core 611 of the first sub-chiplet 600. For example, the security core 511 of the main chiplet 500 can transmit a control signal for blocking the main interface 570 to the security core 611 of the first sub-chiplet 600. The security core 611 of the first sub-chiplet 600 can apply a signal maintained at a logic low level to a second data pad 650 in response to the control signal, or can block transmission and reception of data and signals through the main interface 570 by directly controlling a second main interface sub-system 523.

However, it is not limited to these embodiments, and an operation of the main chiplet 500 blocking the die-to-die interface directly or indirectly can be variously implemented.

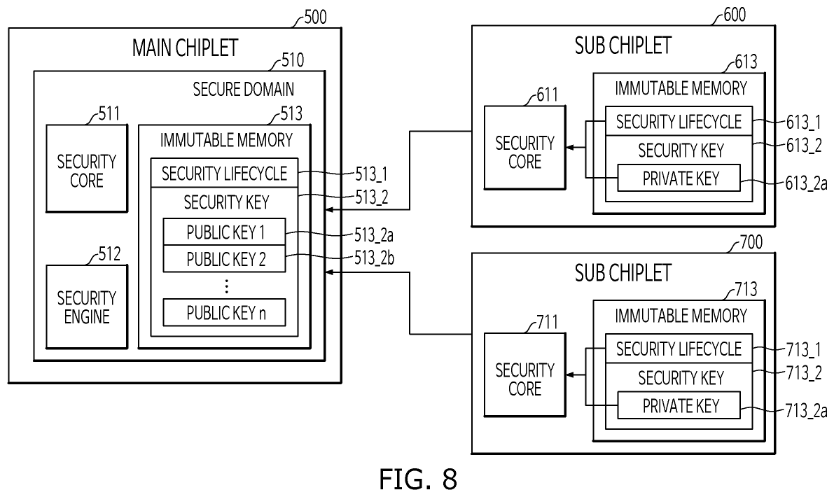

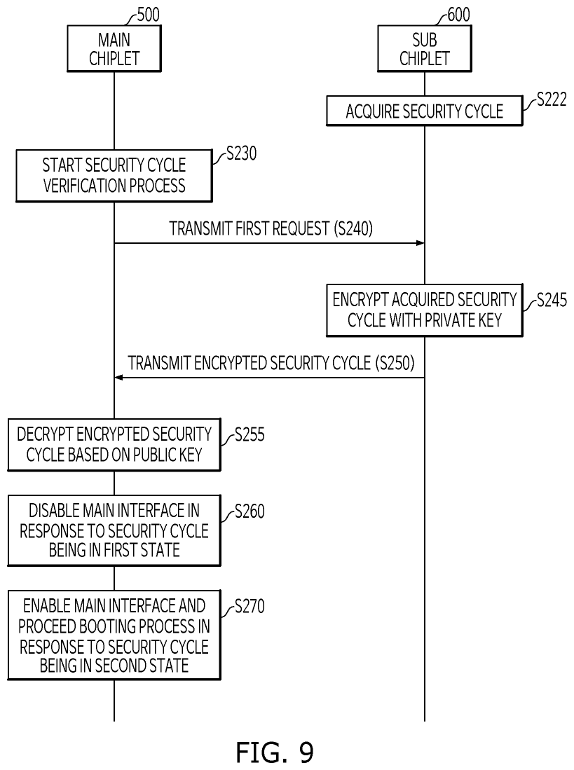

FIG. 8 is a block diagram illustrating an interface control operation through a security key according to an embodiment of the present disclosure. FIG. 9 is a flowchart illustrating the control operation of FIG. 8. Referring to FIG. 8 and FIG. 9, a process of the main chiplet 500 acquiring security cycles of the first sub-chiplet 600 and a second sub-chiplet 700 can proceed by being encrypted with a security key. Descriptions for the first sub-chiplet 600 with reference to FIG. 1 to FIG. 7 can be equally applied to the second sub-chiplet 700.

As described above with reference to FIG. 6, in step S222, the first sub-chiplet 600 can acquire a security cycle from the security cycle area 613_1 of the immutable memory 613. In step S240, the main chiplet 500 can transmit a first request for acquiring the security cycle of the first sub-chiplet 600.

In step S245, the first sub-chiplet 600 can encrypt (or signature) the acquired security cycle with a private key 613_2a. More specifically, the security core 611 of the first sub-chiplet 600 can acquire the private key 613_2a unique to the first sub-chiplet 600 in the security key area 613_2 of the immutable memory 613 in response to the first request. Thereafter, the security core 611 can sign the security cycle through the private key 613_2a. In step S250, the security core 611 of the first sub-chiplet 600 can transmit the encrypted (or signed) security cycle to the main chiplet 500.

In step S255, the main chiplet 500 can decrypt (or verify) the received security cycle with a first public key 513_2a. More specifically, the security core 511 of the main chiplet 500 can acquire the first public key 513_2a corresponding to the first sub-chiplet 600 in the security key area 513_2 of the immutable memory 513. That is, the first public key 513_2a may be a security key corresponding to the private key 613_2a of the first sub-chiplet 600. Thereafter, the security core 511 can decrypt (or verify) the encrypted (or signed) security cycle through the first public key 513_2a. Thereafter, the main chiplet 500 can perform step S260 and step S270 of FIG. 6. For example, when the decrypted security cycle is in the first state (or when it is not data corresponding to the second state due to modification of the security cycle by an attacker), it means that the debugging interface of the first sub-chiplet 600 has been activated by a user without legitimate authority, and thus the main interface can be disabled.

Meanwhile, the main chiplet 500 can verify security cycles of sub-chiplets (for example, the second sub-chiplet 700) other than the first sub-chiplet 600. That is, the main chiplet 500 can transmit a first request for acquiring the security cycle of the second sub-chiplet 700. In response to the first request, a security core 711 of the second sub-chiplet 700 can acquire a private key 713_2a unique to the second sub-chiplet 700 in a security key area 713_2 of an immutable memory 713 in response to the first request. Thereafter, the security core 711 can sign the security cycle acquired from the security cycle area 713_1 through the private key 713_2a. The security core 711 of the second sub-chiplet 700 can transmit the signed security cycle to the main chiplet 500. The security core 511 of the main chiplet 500 can acquire a second public key 513_2b corresponding to the second sub-chiplet 700 in the security key area 513_2 of the immutable memory 513. That is, the second public key 513_2b may be a security key corresponding to the private key 713_2a of the second sub-chiplet 700. Thereafter, the security core 511 can decrypt (or verify) the encrypted (or signed) security cycle through the second public key 513_2b. That is, the security key area 513_2 of the immutable memory 513 of the main chiplet 500 can store public keys corresponding to each of a plurality of sub-chiplets, and the security core 511 can perform a decryption (or verification) operation using a public key corresponding to each sub-chiplet in response to receiving an encrypted security cycle.

Because an attacker can tamper with data inside a chiplet, the attacker may, in response to a transmission request from the main chiplet 500, transmit data indicating that a current security cycle of a sub-chiplet (for example, the first sub-chiplet 600 or the second sub-chiplet 700) is in the second state (for example, an operation stage) to the main chiplet 500. The main chiplet 500 can decrypt data with a public key, thereby recognizing that the current security cycle of the corresponding sub-chiplet is in an abnormal state. Thereafter, the main chiplet 500 can disable the main interface.

An electronic device including a plurality of chiplets according to an embodiment of the present disclosure can increase reliability of a security cycle acquired by the chiplet by performing signature and verification operations for the security cycle through a security key, and can more accurately identify an external intrusion.

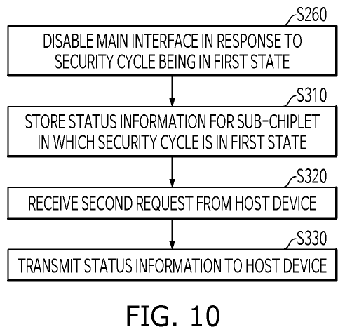

FIG. 10 is a flowchart illustrating a logging operation according to an embodiment of the present disclosure. Referring to FIG. 4, FIG. 6, and FIG. 10, when the main chiplet 500 identifies an external intrusion based on a security cycle of each sub-chiplet, the main chiplet 500 can store log information.

First, as described above with reference to FIG. 6, in step S260, when the security cycle of the first sub-chiplet 600 is in the first state (or when it is not in the second state), the main chiplet 500 can identify that a user without legitimate authority has accessed the first sub-chiplet 600.

In step S310, the main chiplet 500 can store status information for the first sub-chiplet 600 to record such a security status. For example, the main chiplet 500 can store status information indicating that an error has occurred in the security cycle of the first sub-chiplet 600 in the security status area 513_3 of the immutable memory 513.

In step S320, the main chiplet 500 can receive a second request requesting status information of a plurality of chiplets from a host device (for example, the host device 160 of FIG. 1), and in step S330, the main chiplet 500 can transmit the stored status information to the host device. For example, the main chiplet 500 can acquire the status information in the security status area 513_3 of the immutable memory 513 and then transmit the status information to the host device.

However, it is not limited to this embodiment, and a method of reporting status information (or log information) of a plurality of chiplets to the host device can be variously implemented. For example, when the main chiplet 500 recognizes that an error has occurred in a security cycle of a specific sub-chiplet, the main chiplet 500 can store status information or generate a separate flag for the corresponding sub-chiplet, and can transmit the status information to the host device even without a separate request from the host device.

An electronic device including a plurality of chiplets according to an embodiment of the present disclosure can track a security problem by storing corresponding status information when recognizing occurrence of a problem in a security cycle of a chiplet. Also, a security process can be continuously managed through reporting to a host device or the like.

FIG. 11 is a block diagram illustrating an interface control operation during runtime according to an embodiment of the present disclosure. FIG. 12 is a flowchart illustrating the control operation of FIG. 11. Referring to FIG. 11 and FIG. 12, the main chiplet 500 can perform an integrity verification process during runtime, and by including a security cycle in integrity verification data, can perform verification for the security cycle even after a booting process. In FIGS. 11 and 12, configurations overlapping with those described above may be omitted.

The main chiplet 500 can perform an integrity verification process during runtime. To confirm that running firmware and/or a security status is normally maintained without modification, the main chiplet 500 can periodically (or upon occurrence of an event or according to a command of a host) perform an integrity verification process for a plurality of chiplets.

In step S410, the main chiplet 500 can transmit a third request for verification to the first sub-chiplet 600 to perform the integrity verification process. For example, the main chiplet 500 can transmit a verification request signal including a random nonce to the first sub-chiplet 600 according to a fixed period, a specific event, or a command of a host device (for example, the host device 160 of FIG. 1). The nonce may be a temporary value for preventing a replay attack.

In step S420, the first sub-chiplet 600 can acquire a security cycle from the security cycle area 613_1 of the immutable memory 613 in response to the third request of the main chiplet 500.

In step S430, the first sub-chiplet 600 can generate a measurement to transmit integrity verification data to the main chiplet 500 according to an integrity verification request (that is, the third request) of the main chiplet 500. For example, a hash value of stored or currently running firmware can be generated. More specifically, the security core 611 of the first sub-chiplet 600 can calculate a hash value of firmware 613_4a stored in the boot loader area 613_4 of the immutable memory 613, or loaded into main memory and running. For example, the security core 611 can also acquire data about a boot state or a security status in the security status area 613_3 when necessary (or according to a request of the main chiplet 500). The security core 611 can calculate the hash value using the security engine 612. For example, the security engine 612 can generate integrity verification data using the hash value of the firmware 613_4a and the nonce received from the main chiplet 500.

In an embodiment, when the first sub-chiplet 600 generates the integrity verification data as described above, the first sub-chiplet 600 can include the security cycle acquired in step S420. That is, the security core 611 can generate the integrity verification data including the acquired security cycle together with the hash value of the firmware 643_4a.

In step S440, the security core 611 of the first sub-chiplet 600 can sign the generated integrity verification data with the private key 613_2a. More specifically, the security core 611 can acquire the private key 613_2a stored in the security key area 613_2 of the immutable memory 613 to sign the integrity verification data including the security cycle. The security core 611 can sign the integrity verification data including the security cycle using the security engine 612 based on the acquired private key 613_2a.

In step S450, the main chiplet 500 can verify the integrity verification data received from the first sub-chiplet 600 using a public key. More specifically, the security core 511 of the main chiplet 500 can acquire the first public key 513_2a corresponding to the first sub-chiplet 600 (that is, corresponding to the private key 613_2a) in the security key area 513_2 of the immutable memory 513. Thereafter, the security core 511 can verify the signed integrity verification data through the first public key 513_2a. The security core 511 can perform verification using the security engine 512.

In step S460, as a result of verifying the integrity verification data, the security core 511 of the main chiplet 500 can extract the security cycle together with the firmware hash value. When at least one of the hash value or the security cycle is not a reference value and a value corresponding to the second state, the main chiplet 500 can identify that a security problem has occurred. In particular, when the security cycle is not in the second state, it may mean that the debugging interface of the first sub-chiplet 600 is exposed to an external attack. Therefore, thereafter, the main chiplet 500 can perform step S260 and step S270 of FIG. 6. For example, when the decrypted security cycle is in the first state (or when it is not data corresponding to the second state due to modification of the security cycle by an attacker), it means that the debugging interface of the first sub-chiplet 600 has been activated by a user without legitimate authority, and thus the main interface can be disabled.

An electronic device including a plurality of chiplets according to an embodiment of the present disclosure can verify a security cycle in real time or periodically by including a security cycle verification process in an integrity verification process even during runtime after a booting process. That is, a security cycle verification process for a plurality of chiplets can be performed both before and after booting, and reliability of a chiplet system can be further improved.

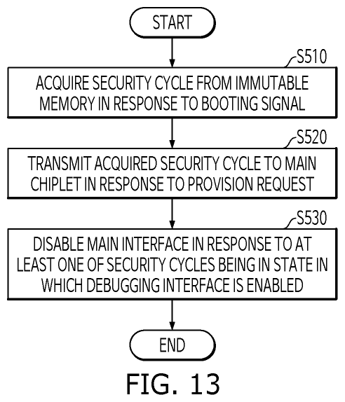

FIG. 13 is a flowchart illustrating a security method of an electronic device including a plurality of chiplets. Referring to FIG. 13, an operation method of an electronic device including a plurality of chiplets according to an embodiment of the present disclosure may include steps S510 to S530. An operation method of a memory device according to an embodiment of the present disclosure can be performed by chiplets (for example, the main chiplet 500 and/or the first sub-chiplet 600), the electronic device 100, and/or a chiplet system described with reference to FIG. 1 to FIG. 12, and duplicate descriptions may be omitted. The electronic device 100 may include the main chiplet 500 and the first sub-chiplet 600.

As described above, for convenience of description, a process in which the main chiplet 500 verifies a security cycle of the first sub-chiplet 600 is described, but the security cycle verification process of the present specification can be performed in parallel for each of a plurality of sub-chiplets including the first sub-chiplet 600.

In step S510, each of the main chiplet 500 and a plurality of sub-chiplets including the first sub-chiplet 600 can acquire a security cycle from each immutable memory in response to a booting signal (or reset signal). In an embodiment, each of the main chiplet 500 and the plurality of sub-chiplets can enable or disable each debugging interface based on the security cycle.

In step S520, the main chiplet 500 can transmit a provision request requesting a security cycle of each of the plurality of sub-chiplets including the first sub-chiplet 600 to each of the plurality of sub-chiplets, and in response to the provision request, the plurality of sub-chiplets can transmit the security cycle acquired in step S510 to the main chiplet 500. In an embodiment, the plurality of sub-chiplets can transmit the security cycle after signing it with a private key, and the main chiplet 500 can check the security cycle of each of the plurality of sub-chiplets by verifying the received security cycle with a public key. In an embodiment, the main chiplet 500 can request a security cycle through an integrity verification process not only during a booting process but also during runtime after completion of booting.

In step S530, the main chiplet 500 can control the main interface based on the security cycle of each of the plurality of sub-chiplets including the first sub-chiplet 600. When at least one of the security cycles of the plurality of sub-chiplets is in the first state (or is not in the second state), it may mean that the debugging interface of the corresponding sub-chiplet has been activated by a user without legitimate authority. The main chiplet 500 can disable the main interface to prevent the entire chiplet system from being exposed to an attack. The main chiplet 500 can disable all main interfaces between chiplets, and in an embodiment, the main chiplet 500 can disable the main interface through clock gating.

The flowcharts described above and the descriptions described above are only examples, and in some embodiments, may be implemented differently. For example, in some embodiments, an order of each step may be changed, some steps may be performed repeatedly, some steps may be omitted, or some steps may be added.

The method described above can be provided as a computer program stored in a computer-readable recording medium for execution in a computer. The medium may continuously store a program executable by a computer, or temporarily store it for execution or download. Also, the medium may be various recording means or storage means in a form in which single or several hardware are combined, and is not limited to a medium directly connected to a certain computer system, but may exist distributed on a network. Examples of the medium may include magnetic media such as a hard disk, a floppy disk, and magnetic tape, optical recording media such as CD-ROM and DVD, magneto-optical media such as a floptical disk, and those configured to store program instructions including ROM, RAM, flash memory, etc. Also, as examples of other media, recording media or storage media managed by an app store that distributes applications or sites, servers, etc. that supply or distribute various other software can be mentioned.

Methods, operations, or techniques of the present disclosure may be implemented by various means. For example, these techniques may be implemented in hardware, firmware, software, or a combination thereof. Those skilled in the art will understand that various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon specific application and design requirements imposed on an entire system. Those skilled in the art may implement the described functionality in various ways for each specific application, but such implementations should not be interpreted as causing a departure from the scope of the present disclosure.

In a hardware implementation, processing units used to perform techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform functions described in the present disclosure, a computer, or a combination thereof.

Accordingly, various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination of those designed to perform functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

In firmware and/or software implementations, techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), magnetic or marking data storage device, etc. Instructions may be executable by one or more processors and may cause the processor(s) to perform certain aspects of functionality described in the present disclosure.

When implemented in software, the techniques described above may be stored on a computer-readable medium as one or more instructions or code or transmitted through a computer-readable medium. Computer-readable media include both computer storage media and communication media including any medium that facilitates transfer of a computer program from one place to another. Storage media may be any available media that can be accessed by a computer. By way of non-limiting example, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line, or wireless technologies such as infrared, radio, and microwave are included within the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known in the art. An exemplary storage medium can be coupled to a processor so that the processor can read information from the storage medium or write information to the storage medium. In the alternative, the storage medium may be integrated into the processor. The processor and the storage medium may reside in an ASIC. The ASIC may reside in a user terminal. In the alternative, the processor and the storage medium may reside as discrete components in a user terminal.

Although the embodiments described above have been described as utilizing aspects of the currently disclosed subject matter in one or more standalone computer systems, the present disclosure is not limited thereto and may be implemented in connection with any computing environment such as a network or distributed computing environment. Furthermore, aspects of the subject matter in the present disclosure may be implemented in a plurality of processing chips or devices, and storage may be similarly affected across a plurality of devices. Such devices may include PCs, network servers, and portable devices.

Although the present disclosure has been described in connection with some embodiments in the present specification, various modifications and changes can be made within a range that does not depart from the scope of the present disclosure that can be understood by those of ordinary skill in the technical field to which the invention of the present disclosure belongs. Also, such modifications and changes should be considered to fall within the scope of the claims appended to the present specification.

1. An electronic device comprising a plurality of chiplets including a main chiplet and at least one sub-chiplet, wherein each of the plurality of chiplets comprises:
a security core configured to control a booting operation;
an immutable memory configured to store a security cycle;
a debugging interface configured to perform communication between the chiplet and an external device performing a debugging operation; and
a main interface configured to perform communication between chiplets,
wherein the main chiplet is configured to determine whether to disable the main interface based on a state of the security cycles of the at least one sub-chiplet.

2. The electronic device as claimed in claim 1, wherein each of the plurality of chiplets is configured to:
acquire the security cycle from the immutable memory in response to a booting signal; and
determine whether to activate the debugging interface based on the security cycle.

3. The electronic device as claimed in claim 2, wherein each of the plurality of chiplets is further configured to:
enable the debugging interface in response to the security cycle being in a first state; and
disable the debugging interface in response to the security cycle being in a second state.

4. The electronic device as claimed in claim 3, wherein the main chiplet is further configured to transmit a first request for acquiring the security cycle of the at least one sub-chiplet,
the at least one sub-chiplet is further configured to transmit the security cycle to the main chiplet in response to the first request.

5. The electronic device as claimed in claim 4, wherein the main chiplet is further configured to disable the main interface of each of the plurality of chiplets in response to at least one of the security cycles received from the at least one sub-chiplet being in the first state.

6. The electronic device as claimed in claim 4, wherein the main chiplet is further configured to disable the main interface of each of the plurality of chiplets in response to at least one of the security cycles received from the at least one sub-chiplet being not in the second state.

7. The electronic device as claimed in claim 4, wherein the main chiplet is further configured to output a control signal so that the security core of each of the at least one sub-chiplet disables the main interface of each of the at least one sub-chiplet, in response to at least one of the security cycles received from the at least one sub-chiplet being in the first state.

8. The electronic device as claimed in claim 5, wherein the main chiplet is further configured to gate a clock signal applied to the main interface of each of the plurality of chiplets.

9. The electronic device as claimed in claim 5, wherein each of the plurality of chiplets further comprises a sub-interface configured to preliminarily perform communication between chiplets, and
the main chiplet is further configured to disable the sub-interface of each of the plurality of chiplets.

10. The electronic device as claimed in claim 4, wherein the immutable memory of the main chiplet is further configured to store a public key corresponding to each of the at least one sub-chiplet, the immutable memory of each of the at least one sub-chiplet being further configured to store a private key paired with the public key.

11. The electronic device as claimed in claim 10, wherein the at least one sub-chiplet is further configured to encrypt the acquired security cycle with the private key in response to the first request, the main chiplet being further configured to decrypt the encrypted security cycle based on the public key paired with the private key.

12. The electronic device as claimed in claim 5, wherein the main chiplet is further configured to store, in the immutable memory, status information for the at least one sub-chiplet in which the security cycle is in the first state.

13. The electronic device as claimed in claim 12, wherein the main chiplet is further configured to:
receive a second request for checking a security status of the plurality of chiplets from a host device; and
transmit the status information to the host device in response to the second request.

14. The electronic device as claimed in claim 13, wherein the main chiplet further comprises a PCIe (peripheral component interconnect express) interface configured to perform communication with the host device, the main interface including a UCIe (universal chiplet interconnect express) interface.

15. The electronic device as claimed in claim 1, wherein the main chiplet is further configured to transmit a third request for integrity verification to each of the at least one sub-chiplet during runtime after completion of the booting operation, and
each of the at least one sub-chiplet is further configured to transmit integrity verification data including a corresponding security cycle to the main chiplet in response to the third request.

16. A chiplet system comprising a plurality of chiplets including a main chiplet and at least one sub-chiplet, wherein each of the plurality of chiplets comprises:
a security core configured to control a booting operation;
an immutable memory configured to store a current security cycle;
a debugging interface configured to perform communication between the chiplet and an external device performing a debugging operation; and
a main interface configured to perform communication between chiplets, wherein each of the plurality of chiplets is configured to acquire the security cycle from the immutable memory in response to a booting signal, the at least one sub-chiplet is configured to transmit the acquired security cycle to the main chiplet in response to a provision request for security cycle by the main chiplet, and
the main chiplet is further configured to disable the main interface of each of the plurality of chiplets in response to at least one of the security cycle received from the at least one sub-chiplet being not in a state in which the debugging interface is disabled.

17. The chiplet system as claimed in claim 16, wherein the immutable memory of the main chiplet is further configured to store a public key corresponding to each of the at least one sub-chiplet,
the immutable memory of each of the at least one sub-chiplet is further configured to store a private key corresponding to the public key,
the at least one sub-chiplet is further configured to encrypt the security cycle with the private key in response to the provision request, and
the main chiplet is further configured to decrypt the encrypted security cycle based on the public key corresponding to the private key.

18. The chiplet system as claimed in claim 17, wherein the main chiplet is further configured to gate a clock signal applied to the main interface of each of the plurality of chiplets.

19. The chiplet system as claimed in claim 16, wherein the main chiplet is further configured to transmit a verification request for integrity verification to each of the at least one sub-chiplet during runtime after completion of the booting operation, and
each of the at least one sub-chiplet is further configured to transmit integrity verification data including a corresponding security cycle to the main chiplet in response to the verification request.

20. A security method of an electronic device comprising a plurality of chiplets including a main chiplet and at least one sub-chiplet, each of the plurality of chiplets including a security core configured to control a booting operation, an immutable memory configured to store a current security cycle, a debugging interface configured to perform communication between the chiplet and an external device performing a debugging operation, and a main interface configured to perform communication between chiplets, the security method comprising:
acquiring, by the at least one sub-chiplet, the security cycle from the immutable memory in response to a booting signal;
transmitting, by the at least one sub-chiplet, the acquired security cycles to the main chiplet in response to a provision request for the security cycles of the main chiplet; and
disabling, by the main chiplet, the main interface of each of the plurality of chiplets in response to at least one of the security cycles received from the at least one sub-chiplet being in a state in which the debugging interface is enabled.
